(19) United States
(12) Patent Application Publication
(10) Pub. No.: US 2015/0217188 A1
(43) Pub. Date: Aug. 6, 2015

(54) PHYSICAL INTERACTION DEVICE FOR PERSONAL ELECTRONICS AND METHOD FOR USE

(71) Applicant: Physical Apps, LLC, Hollis, NH (US)

(72) Inventors: Robert C. Houvener, Hollis, NH (US); Brian Sullivan, Acton, MA (US); Richard S. Malagodi, Hollis, NH (US)

(73) Assignee: Physical Apps, LLC, Hollis, NH (US)

(21) Appl. No.: 14/174,762

(22) Filed: Feb. 6, 2014

(51) Int. Cl. A63F 13/211; A63F 13/285; A63F 13/24

(52) U.S. Cl. CPC A63F 13/211; A63F 13/24; A63F 13/285

(57) ABSTRACT

The present disclosure describes, among other things, a method that may include receiving, at one or more sensors in communication with a mobile computing device positioned within a device receptacle portion of a device, the device receptacle portion being configured to substantially enclose and protect the mobile computing device during physical activity, sensor data. The method may include determining, by a processor of the mobile computing device, motion data regarding a movement of the protective device. The method may include estimating a behavior of a user based in part upon the motion data. The method may include generating a response to the behavior including at least one of graphic, audio, tactile, or video output. The method may include providing, through a wireless communications path, the response to a second device in wireless communication with the mobile computing device.

### RELATED APPLICATIONS

This application is a continuation-in-part of U.S. patent application Ser. No. 13/348,434, filed on Jan. 11, 2012, and titled “Physical Interaction Device for Personal Electronics and Method for Use”, which claims priority to U.S. Provisional Application No. 61/468,369, entitled “Physical Interaction Enabling Protective Device and Method of Using Same” and filed Mar. 28, 2011, and U.S. Provisional Application No. 61/538,361, entitled “Physical Interaction Enabling Protective Device and Method for Wireless Electronic Personal Equipment” and filed Sep. 23, 2011, the contents of each of which are hereby incorporated by reference in their entirety.

This application is related to application Ser. No. 13/348,433, filed on Jan. 11, 2012, and titled “Physical Interaction Device for Personal Electronics and Method for Use”, Ser. No. 14/174,369, filed on Feb. 6, 2014, and titled “Methods and Apparatus for the Retention of a Personal Electronics Device within a Physical Interaction Device”, each hereby incorporated by reference.

### BACKGROUND

Personal electronic devices may include smart phones, multi-media players, portable music players, digital cameras, handheld gaming systems, and other devices for communication and entertainment. In some implementations, personal electronic devices may be capable of wirelessly connecting to a network, for example via Wi-Fi™ or a cellular carrier. Personal electronic devices, in some implementations, may include one or more features such as voice recognition, voice based control, motion sensing, location sensing, one or more microphones, one or more speakers, one or more video and/or audio outputs, and input mechanisms such as QWERTY keyboard controls, buttons, track balls, and touch screen control elements.

Various case technology has been developed to protect personal electronic devices from damage, for example due to being dropped, scratched, or exposed to conditions that could harm the internal circuitry. Docking stations and other apparatus for releasably retaining personal electronics have also been developed, for example to enable power charging of the personal electronic device or to connect the personal electronic device to peripheral technology, such as audio speakers.

### SUMMARY

In one aspect, the present disclosure describes a method of implementing an interactive competitive-cooperative game involving a plurality of physical interaction devices each containing a mobile computing device. The each of the plurality of physical interaction device may include at least one of an open cell foam, a closed cell foam, a foamed resin, and an inflatable bladder. For example, the physical interaction device may be a disk-shaped physical interaction device.

The method, in certain embodiments, includes receiving, by a processor of a first mobile computing device, a signal from each of one or more sensors associated with the first mobile computing device responsive to a movement of the first mobile computing device. The first mobile computing device may be positioned within an interior receptacle portion of a first physical interaction device, the interior receptacle portion being configured to substantially enclose and protect the first mobile computing device during movement. In some implementations, a first plurality of users cooperate to move the first physical interaction device.

In certain embodiments, the method includes generating a first response to the movement of the first mobile computing device, said response comprising graphic output and, optionally, one or more of audio and tactile output. The method may include receiving, from a second mobile computing device positioned within an interior receptacle portion of a second physical interaction device, a second response to a behavior of a second plurality of users of the second physical interaction device based in part upon movement of the second physical interaction device determined from one or more sensors of the second mobile computing device. In some implementations, the second plurality of users cooperate to move the second physical interaction device.

In certain embodiments, the method includes providing, for simultaneous display on a graphical user interface of the first mobile computing device, the first response and the second response. Thus, a group of players may engage in an interactive competitive-cooperative game involving a plurality of physical interaction devices each containing a mobile computing device. The mobile computing devices may be different types of devices and/or use different operating systems. For example, the first mobile computing device may be a smart phone and the second mobile computing device may be a tablet computing device.

The first physical interaction device may include a housing comprising a material selected from one or more of open cell foam, closed cell foam, foamed resin, and an inflatable bladder, and the second physical interaction device may include a housing comprising a material selected from one or more of open cell foam, closed cell foam, foamed resin, and an inflatable bladder. In certain embodiments, the housing of the first physical interaction devices is a disk-shaped housing sized and shaped such that each user of the first plurality of users can touch a side of said housing causing said housing to tilt in a direction of a touch, and the housing of the second physical interaction device is a disk-shaped housing sized and shaped such that each user of the second plurality of users can touch a side of said housing causing said housing to tilt in a direction of a touch. The housing of the first physical interaction device may include a window/opening for viewing of the first mobile computing device when retained within the interior receptacle portion and the housing of the second physical interaction device may also include a window/opening for viewing of the second mobile computing device when retained within the interior receptacle portion.

In certain embodiments, the housing of the first physical interaction device and the housing of the second interaction device each include one or more unique marks associated with a mobile application operating on the first mobile computing device and a mobile application operating the second mobile computing device, respectively. The one or more unique marks include a heart, a spade, a club, and a diamond.

In another aspect, the disclosed technology provides a physical interaction device with a disk-shaped housing sized and shaped such that one or more users can touch a side of the housing causing the housing to tilt in a direction of the touch. The housing may include a first interior receptacle sized and shaped to removably receive a first personal electronic device therewithin. The first interior receptacle may include at least one undercut such that an edge of the first personal electronic device, upon positioning of the device within the first interior receptacle, is secured within the at least one undercut to firmly retain the first personal electronic device within the first interior receptacle.

In certain embodiments, the physical interaction device includes a removable insert sized and shaped to fit within the first interior receptacle. The removable insert may include a second interior receptacle sized and shaped to removably receive a second personal electronic device therewithin. In certain embodiments, the second interior receptacle is smaller in two dimensions than the first interior receptacle. The first and second personal electronic device are handheld off-the-shelf electronic devices, such as smart phones or tablet computing devices. For example, the first personal electronic device may be a tablet and the second personal electronic device may be a cellular phone.

In certain embodiments, the physical interaction device is sized and shaped to (i) substantially enclose and protect the personal electronic device within the interior receptacle during physical activity comprising at least one of rolling the device, throwing the device, kicking the device, and striking the device against another object, and (ii) enable interaction with the personal electronic device while the personal electronic device is substantially enclosed within the device. The housing may include a window/opening for viewing of the first personal electronic device when retained within the interior receptacle and the removable insert comprising a window/opening for viewing of the second personal electronic device when retained within the interior receptacle.

In certain embodiments, the physical interaction device is configured to be used as cooperative-competitive gaming equipment. The housing may include one or more unique marks associated with a mobile application operating on at least one of the first personal electronic device and the second personal electronic device. The one or more unique marks may include a heart, a spade, a club, and a diamond.

In certain embodiments, the housing includes a top, bottom, and one or more edges between the top and bottom. The housing may include a width of the housing is larger than a thickness of the housing, wherein the thickness of the housing varies such that the thickness at the one or more edges is smaller than the thickness at a center of the housing.

In certain embodiments, the second interior receptacle includes at least one receptacle undercut such that an edge of the second personal electronic device, upon positioning of the device within the second interior receptacle, is secured within the at least one receptacle undercut to firmly retain the second personal electronic device within the second interior receptacle.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is an illustration of an example disk-shaped protective device;

FIG. 2 is an illustration of the bottom-side of an example disk-shaped protective device;

FIG. 3 is an illustration of an example disk-shaped protective device with a removable insert;

FIG. 4 is an illustration of an example disk-shaped protective device with a removable retention mechanism for holding a personal electronic device;

FIG. 5A is an illustration of an example use for a disk-shaped physical interaction device;

FIG. 5B is an illustration of an example disk-shaped physical interaction device;

FIG. 6 is an illustration of an example use for an active play toy including a protective encasement;

FIG. 7 is a swim diagram illustrating an example method for using a personal electronic device encased in a protective device;

FIG. 8 is a swim lane diagram detailing example interactions, provided for in some implementations, between a personal electronic device, an application cloud, and a second user device;

FIG. 9 is a flow chart of an example method of implementing an interactive competitive-cooperative game involving a plurality of physical interaction devices each containing a mobile computing device;

FIG. 10 is an example labyrinth game played using a physical interaction device;

FIG. 11 is a block diagram of an example network environment for interaction with a personal electronic device via a protective device;

FIG. 12 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to a system and method for interacting with a personal electronic device encased in a protective encasement of a physical interaction-enabling device. A physically protective, light weight and cost-effective covering or encasement for a personal electronic device, in some implementations, may enable use of an off-the-shelf personal electronic device as a game play and learning system. A personal electronic device, in some examples, may include a handheld consumer electronic device, cellular phone, smart phone, multimedia device, personal entertainment device, handheld gaming device, personal digital assistant, or other small computing device.

In some implementations, a personal electronic device may be positioned in a protective enclosure of a protective device to encourage physical interaction with the personal electronic device, without the fear of injury or harm to the personal electronic device itself, to players or surroundings.

The protective device and/or protective encasement, in some implementations, may be constructed of any material capable of absorbing physical shock, thereby protecting the personal electronic device. In some implementations, the protective device may additionally absorb physical shock in a manner that protects users interacting with the protective device as well as the surroundings. In some examples, construction materials of the protective device may include closed cell foams, open cell coated foams, and/or inflatable chambers. A protective chamber region of the protective device, in some implementations, may protect the device from environment damage (e.g., sand, dust, water, snow, etc.), for example by providing a waterproof seal.

In some implementations, a personal electronic device may be encased in a protective enclosure of a protective device to provide protection to the personal electronic device during physical gaming (e.g., where the personal electronic device may be moved about at high velocity, thrown, or shaken). For example, a personal electronic device may be encased in a ball-shaped protective enclosure during a game of media rich “hot potato” where the ball-shaped protective device is tossed from person to person until an indication of game end is presented (e.g., alarm goes off, music stops playing, etc.).

In some implementations, the protective device may include a volume substantially larger than the protective enclosure. For example, the protective device may have a volume at least three times as large as a volume of the personal electronic device. The volume of the protective device, in some implementations, may be substantially hollow, for example allowing the protective device to be light weight or to encourage air flow around a portion of the personal electronic device to aid in cooling of the personal electronic device while encased in the protective enclosure of the protective device.

To engage in interactive play via the personal electronic device encased in the protective device, in some implementations, a user may execute a software application installed in part upon the personal electronic device. In some examples, the software application may come pre-installed upon the personal electronic device, or the user may download the software application from directly connected (e.g., removable memory drive) or networked media storage. In some implementations, the protective device may be sold with one or more software applications or with instructions for accessing one or more software applications designed to enhance the use of the protective device.

In some implementations, a user may visit a web site to shop for and purchase one or more software applications designed for interactive play with a handheld computing device installed within a protective device. For example, via a browsing mechanism available on the personal electronic device or other personal computing device, a user may select one or more software applications to install upon the handheld computing device.

In some implementations, a user may access a software application interface to configure or personalize a software application for use with the protective device. For example, a user may be provided the opportunity to customize an application (e.g., audio settings or custom audio files, video settings or custom video files, voice recognition settings, data collection settings, etc.) through the personal electronic device, or through a web site or online application accessible via another personal computing device. In a particular example, a teacher may select or input a set of trivia questions or spelling words to be used in a physical learning game in a classroom environment. For example, a ball-shaped protective device may be tossed between students, where the student is asked one of a series of questions when the ball is caught. In some implementations, the particular question asked may be based in part upon an orientation of the personal electronic device within the ball-shaped protective device. The questions, in some implementations, may be provided in a randomized order. In some implementations, the questions may be displayed upon a screen area of the personal electronic device which is visible to the student. The question, in some implementations, may be asked audibly, for example through one or more speakers built into the personal electronic device or in communication with the personal electronic device.

In some implementations, a user may be provided the opportunity to build an application configured for interaction with the protective device and to install the application upon the personal electronic device. For example, a user may select and customize existing modules to create a unique software application for interaction with the protective device.

A same software application may be installed upon two or more electronic devices, in some implementations, such that the two or more electronic devices may each be used in interactive play, each of the two or more electronic devices being inserted into a respective protective device. For example, the two or more electronic devices may share data via a wireless network connection during interactive play to provide near real-time interaction between the two devices. In some implementations, the two or more electronic devices may be located in remote locations. For example, a first player in a first geographic location may engage in an interactive game with a second player in a second geographic location.

In some implementations, one or more electronically coupled devices, such as external speakers, microphones, display devices, and remote control devices (e.g., installed interior and/or exterior to the protective enclosure) may be included as part of the media-rich experience provided by the protective device. One or more electronically coupled devices, in some implementations, may be positioned external to the protective device and connected to the personal electronic device and/or the protective device via a wired or wireless connection. In some implementations, one or more peripheral devices may be installed within the protective device and directly or wirelessly connect to the personal electronic device.

In some implementations, the protective device may include no additional electronics beyond the personal electronic device. For example, an existing personal electronic device may be placed within a protective enclosure of a protective device and a user may access the capabilities of the personal electronic device to engage in a game or learning experience via, for example, a software application executing in part upon the personal electronic device.

In some implementations, a software application running on the personal electronic device may wirelessly communicate with one or more networked devices (e.g., a tablet, laptop, television, digital display, audio speaker, etc.) to enhance and expand the user experience. Further to the example, in some implementations, user data may be stored on the personal electronic device, a networked user device, or in remote network storage (e.g., within an application cloud) for access and use by the user of the personal electronic device or by others (e.g., a coach, doctor, parent, etc.) interested in monitoring data collected via the personal electronic device. Stored data, in some examples, may be accessed in real time or collected and reviewed as historical data.

In some implementations, a personal electronic device may be encased in a protective enclosure of a protective device to enable a user with physical and/or mental limitations to more easily or more safely interact with the personal electronic device. In some implementations, the protective enclosure may be designed for interaction with small children, elderly persons, those with forms of physical ailments such as recoveries from bone or muscle injuries, those with long term physical ailments such as multiple sclerosis etc, and those with forms of dementia.

In some implementations, a patient may utilize a personal electronic device enclosed in a protective enclosure of a protective device to perform rehabilitating work while data regarding progress and/or results of rehabilitative tasks accomplished via the personal electronic device may be recorded and utilized by the user and/or those assisting the user in their rehabilitative activities. In a particular example, a rehabilitative professional may access the data (e.g., via a user interface such as a web page) to review activities that a patient performed. Data collected during interaction with a personal electronic device encased in a protective device, in some implementations, may include detailed statistics recorded by one or more software applications executed in part upon the personal electronic device.

In some implementations, a personal electronic device may be enclosed in a protective enclosure of a protective device to facilitate interaction with the personal electronic device during physical exercise. In some implementations, the protective device may be designed as a piece of exercise equipment, similar to a heavy exercise ball (e.g., medicine ball, kettle), barbell, dumbbell, liquid or gel-weighted shape, or other weight training exercise equipment; a boxing glove, heavy bag, speed bag, standing heavy bag, virtual sparring partner, or other combat-training exercise equipment; a stability disc, wobble board, yoga ball, or other balance and coordination training exercise equipment; or a playground ball, football, basketball, soccer ball, flying disc, baseball bat, or other sports game equipment or recreational equipment. In some implementations, software functioning in part on the personal electronic device may be used to coach a player during physical exercise or track performance during an exercise workout. In some examples, sensors such as an accelerometer, positioning sensor, orientation sensor, global positioning sensor, gyroscope, light sensor, imaging sensor, acoustic sensor, microphone, camera, or other external sensing device may provide data to software functioning in part on the personal electronic device to determine behaviors (e.g., velocity, trajectory, rotational speed) of the protective device or of the user during physical exercise.

In some implementations, a personal electronic device may be enclosed in a protective enclosure of a protective device to facility multi-media rich imaginative play. For example, a personal electronic device may be installed within a protective enclosure designed as a child's toy. One or more sensors within or communicating with the personal electronic device, for example, may provide input to a software application regarding a child's interactions with the toy. In response to sensed interactions, in some examples, the software application may output lights, colors, images, audio, video, vibrations, or other feedback responsive to the child playing with the toy.

While a personal electronic device is encased in a protective device, in some implementations, a user may control the personal electronic device via voice commands. For example, a voice recognition component of the personal electronic device may recognize one or more commands to control the personal electronic device and/or one or more software applications providing a media-rich interactive experience with the protective device via the personal electronic device. Commands, in some examples, may include launching of one or more software applications, configuring one or more software application options, and configuring device options (e.g., volume control, power off, etc.).

In some implementations, a software application executing upon the personal electronic device may determine the identity of a particular player interacting with the personal electronic device. Player identification, in some implementations, may be accomplished via a touch input, such as via one or more button inputs or virtual control inputs such as a virtual keyboard rendered on a screen area of the personal electronic device. In other implementations, the software may utilize one or more biometric identification techniques, such as voice, facial feature, or fingerprint recognition, for example utilizing one or more sensors and/or sensor input applications. For example, biometric identification techniques may be available on the personal electronic device or through software modules accessible via one or more computer networks accessible to the personal electronic device. In some implementations, player identification may be accomplished while the personal electronic device is encased in a protective device. In some implementations, one or more unique identifiers may be mapped to a particular game player such as, in some examples, barcodes or radio-frequency identification (RFID) chips provided in or on a wrist band, card, or other separate identification mechanism. In some implementations, a user may download a unique game player code to the personal electronic device, and the software may access the unique game player code within a memory location of the personal electronic device to identify the game player.

Similarly, in some implementations, the individual protective device may be identified by one or more software applications executing on the personal electronic device. For example, one or more printed bar codes, radio frequency identification chips, or other unique identifiers may be included within or upon the protective device, enabling either a general identification (e.g., round ball versus football) or a unique identification (e.g., individually-purchased item) of the protective device. In some implementations, the personal electronic device may be used to read an identifying marker, for example by using one or more sensors such as a bar code reader, camera, imaging system, or RFID sensor resident to the personal electronic device. The personal electronic device, in some implementations, may utilize that information to customize user experience, for example during game play or other interaction.

In some implementations, recognition of a type of protective device, a uniquely identified protective device, and/or a uniquely identified game player may be used to customize and enhance presentation of one or more games for use with the protective device. In some implementations, unique audio, graphic, or video input may be provided based in part upon identification of the protective device. For example, upon recognition that the protective device was sold with an exterior design of a licensed character, catch phrases of the licensed character, a voice of the licensed character, and/or one or more images or videos of the licensed character may be provided to the game player during interactive play. In some implementations, unique identification of a user may allow the software application to store information (e.g., high score, preferences, historical performance data, etc.) associated with the unique user on the personal electronic device and/or at a remote storage location on a computer network accessible to the personal electronic device.

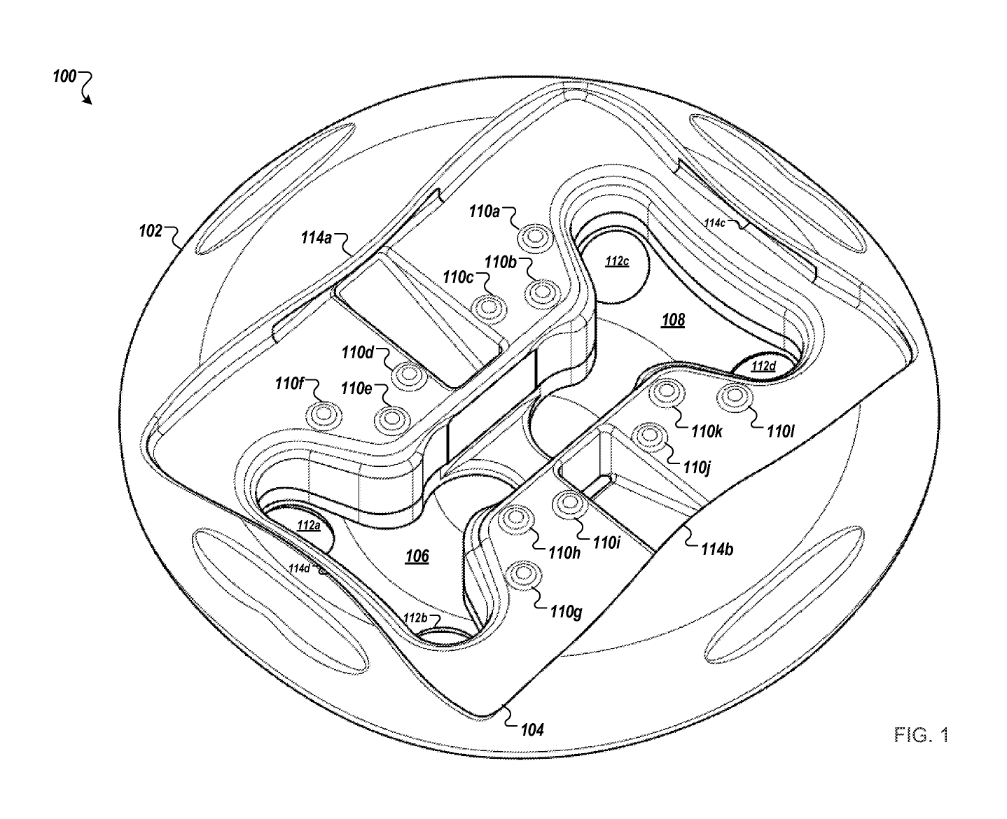

Turning now to FIG. 1, some implementations of a game-enabling physical interaction device may include a disk-shaped structure 102 having an internal receptacle 104 for housing a personal electronic device. As illustrated in FIG. 1, the disk-shaped structure 102 may permit a personal electronic device to be inserted into the receptacle 104 with a screen area of the personal electronic device facing up.

The disk-shaped structure 102, in some implementations, may be constructed in part using a foam material. Furthermore, the foam material, in some implementations, may generally protect users, bystanders and/or other physical items such as furniture etc., from damage or injury due to physical impact with the disk-shaped physical structure 102. In some implementations, the disk-shaped structure 102 may include cavities such as a first cavity 106 and/or a second cavity 108 which may work to reduce the weight of the disk-shaped structure 102, lower the cost of manufacture of the disk-shaped structure 102, and/or provide areas to stow accessories (e.g., input/output devices, storage devices, etc.). For example, one or more audio output devices may be provided within the first cavity 106 or the second cavity 108.

Once the personal electronic device has been placed within the interior receptacle 104 of the disk-shaped structure 102, in some implementations, a user may interact directly with the personal electronic device via one or more cut-outs in the structure of the disk-shaped structure 102. One or more of the cut-outs, in some implementations, may be aligned to allow a user to interact with an audio or visual element of the personal electronic device 1 while the personal electronic device is in the disk-shaped structure 102. In some implementations, once the personal electronic device has been placed within the interior receptacle 104 of the disk-shaped structure 102, the personal electronic device is fully encompassed by an outer diameter of the disk-shaped structure 102.

In some implementations, the cut-outs 106 and 108 may each be designed to provide access to a particular feature of the personal electronic device, such as, but not limited to, one or more speaker(s), a portion of the screen area, a microphone, a camera lens, and/or a physical control (e.g., power button, volume adjustment, etc.). In some implementations, the screen area may be substantially visible via an opening of the receptacle 104 such that players may view a substantial portion of the screen area by looking down through the opening of the receptacle 104. In some implementations, the opening may be designed such that the screen area may be substantially protected from a direct impact. The opening of the receptacle 104, in some implementations, may include a transparent protective material, allowing visual access to the screen area of a personal electronic device fully inserted into the receptacle 104 but no physical access.

In some implementations, rather than providing physical access to one or more physical controls of the personal electronic device, including, for example, a touch screen style screen area, the personal electronic device may be configured with voice recognition capabilities. For example, while the personal electronic device may be encased by the disk-style structure 102, a user may launch one or more software applications, adjust device settings (e.g., increase or decrease volume, power off, etc.), or adjust software application settings (e.g., input number of players for a particular game, select difficulty level for a particular game, etc.) without removing the personal electronic device from the disk-style structure 102 through one or more voice commands.

In some implementations, one or more bumpers 110a-1 may be utilized at various locations in receptacle 104, for example to firmly secure a personal electronic device fully inserted into the receptacle 104. For example, the bumpers 110a-1 may allow a range of compression to accommodate various sizes of personal electronic devices in the receptacle 104.

In some implementations, as described above, a game-enabling physical interaction device 100 may include an interior receptacle 104 for housing a personal electronic device. For example, the game-enabling physical interaction device 100 may include an exterior shell, where the interior receptacle 104 extends inwards from the exterior shell to house the personal electronic device. In some examples, a user may insert the personal electronic device into the receptacle 104 in a generally screen area up or screen area down orientation. By inserting the personal electronic device in the game-enabling physical interaction device 100 in a generally screen area up orientation, in some implementations, the user may maintain visual access to the screen area of the personal electronic device during game play.

In some implementations, the interior receptacle 104 is a slot in the game-enabling physical interaction device 100 that allows a user to insert the personal electronic device in a lengthwise or width-wise manner into the game-enabling physical interaction device 100.

For example, by inserting the personal electronic device into a slot (not illustrated) of the game-enabling physical interaction device 100, the screen area of the game-enabling physical interaction device may, in some implementations, be obscured from the user within the game-enabling physical interaction device 100.

In some implementations, one or more walls of the interior receptacle 104 may include holes or perforations, such as holes 112a-d. In some examples, holes or perforations in the walls of the receptacle 104 may aid in air circulation and cooling of the personal electronic device and/or in enabling sound to carry from one or more speakers of the personal electronic device to the game player.

Although illustrated as a disk, in some implementations the game-enabling physical interaction device 100 may be formed in a different shape such as, in some examples, a football, sphere, oblong, novelty toy, or piece of exercise equipment. The game-enabling physical interaction device 100, in some implementations, may be formed of a flexible elastomeric material that deforms upon impact. For example, the material of the game-enabling physical interaction device 100 may be selected to absorb forces which may otherwise damage the personal electronic device. In some implementations, the material of the game-enabling physical interaction device 100 may be chosen to include a type of material that returns to an original shape once a force has ceased to be applied (e.g., post-deformation). A game player, in some implementations, may minimally assist in returning the game-enabling physical interaction device 100 from a deformed shape caused by a physical force to an original shape. An example of such a material is a polyurethane foam resin.

As illustrated in the interior receptacle 104 of the game-enabling physical interaction device 100 of FIG. 1, one or more flexible and/or deformable bumps 114a-d may be situated surrounding or abutting a personal electronic device that is fully inserted into the interior receptacle 104. The deformable bumps 114a-d (e.g., convex surfaces), in some implementations, may enhance the ability of the receptacle 104 to successfully hold personal electronic devices of various dimensions. For example, using the deformable bumps 114a-d, a wide variety of shapes and sizes personal electronic devices may be maintained within the receptacle 104 without need for separate adapters. In some implementations, to secure the personal electronic device into the back of the receptacle 104, a user may compress the deformable bumps 114a-d during insertion of the personal electronic device, then allow the deformable bumps 114a-d to expand, thereby pressing the personal electronic device firmly against one or more surfaces of the receptacle 104. In some implementations, the deformable bumps 114a-d may be positioned at points surrounding the personal electronic device when it is fully inserted into the receptacle 104. In some implementations, a combination of convex areas (e.g., deformable bumps 114a-d) with flat and/or concave surfaces may encourage air flow around the personal electronic device when it is fully inserted into the receptacle 104. The combination of convex areas with flat and/or concave surfaces, in some implementations, may enhance the transmission of sound from the personal electronic device when it is fully inserted into the receptacle 104.

In some implementations, a protective device may be fabricated from open cell or skinned open cell foam such as, for example, foams that form a skin-like surface on the outside of the material as it cures during manufacturing of the foam shape. Although the foam protective enclosure 100, as illustrated, has a disk shape, in other implementations, a protective device may be fabricated from open cell or skinned open cell foam in a variety of shapes and sizes, depending in part upon the intended use of the protective device.

In some implementations, a protective device such as the foam protective enclosure may be surrounded by an external slip cover. A slip cover may be installed upon the exterior of the foam protective enclosure to protect, personalize, and/or decorate the foam protective enclosure. In some implementations, the slip cover may be branded or licensed by a corporation to enhance marketing appeal of the foam protective enclosure. The slip cover, in some implementations, may be manufactured using a stretchy material such as, in some examples, lycra, nylon, spandex, polyester, cotton jersey, or a combination thereof. In some implementations, the slip cover may include additional protective features, such as water resistance, floatation, and/or enhanced durability. In some examples, protective fabric contents can include Cordura® nylon, polyurethane, neoprene, and foamed neoprene.

Although initially described in relation to the disk-shaped structure 100, in other implementations, a protective device including a protective enclosure for encompassing the personal electronic device or other various shapes and sizes of personal electronic devices may take various forms of imaginative play-enabling devices such as ball-shaped structure, inflatable or stuffed children's toys, turning would-be passive stuffed/inflatable toys into highly interactive multi-media rich interactive items.

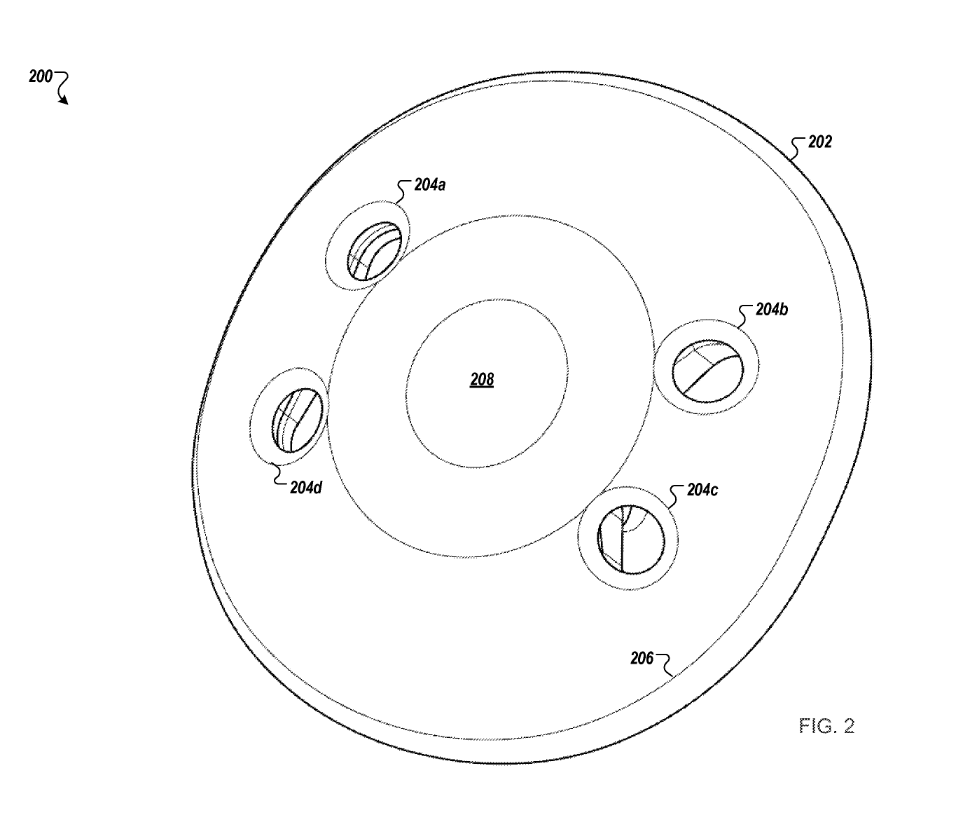

FIG. 2 illustrates an example underside of a disk-shaped physical interaction device 200, such as the disk-shape physical interaction device shown in FIG. 1. In some implementations, the disk-shaped physical interaction device has a disk-shaped housing 202 sized and shaped such that one or more users can touch a side of the housing causing the housing to tilt in a direction of the touch. The disk-shaped housing 202 may include a top, bottom, and one or more edges 206 between the top and bottom. In some implementations, the width of the disk-shaped housing 202 is larger than a thickness of the housing 202. The thickness of the disk-shaped housing 202 varies such that the thickness at the one or more edges 206 is smaller than the thickness at a center 208 of the housing. Such as device 200 may be used as a wobble board and/or in various games as described below, such as, for example, a labyrinth game, spaceship obstacle course game, or a trivia game.

In some implementations, the body 202 may include holes or perforations that connect to the interior receptacle of the physical interaction device, such as holes 204a-d. In some examples, holes or perforations may aid in air circulation and cooling of the personal electronic device and/or in enabling sound to carry from one or more speakers of the personal electronic device to the game player.

In order to accommodate various sizes of personal electronic devices, in some implementations, adapters may be used to aid in filling excess space in the interior receptacle, thereby enabling the disk-shaped structure to accommodate a variety of different shapes and sizes of personal electronic devices. In this manner, for example, a single disk-shaped device may accommodate a variety of personal electronic devices owned by a household, and in upgrading from one personal electronic device to another, the owner of the disk-shaped structure may not find it necessary to purchase a new disk-shaped structure to accommodate a new personal electronic device.

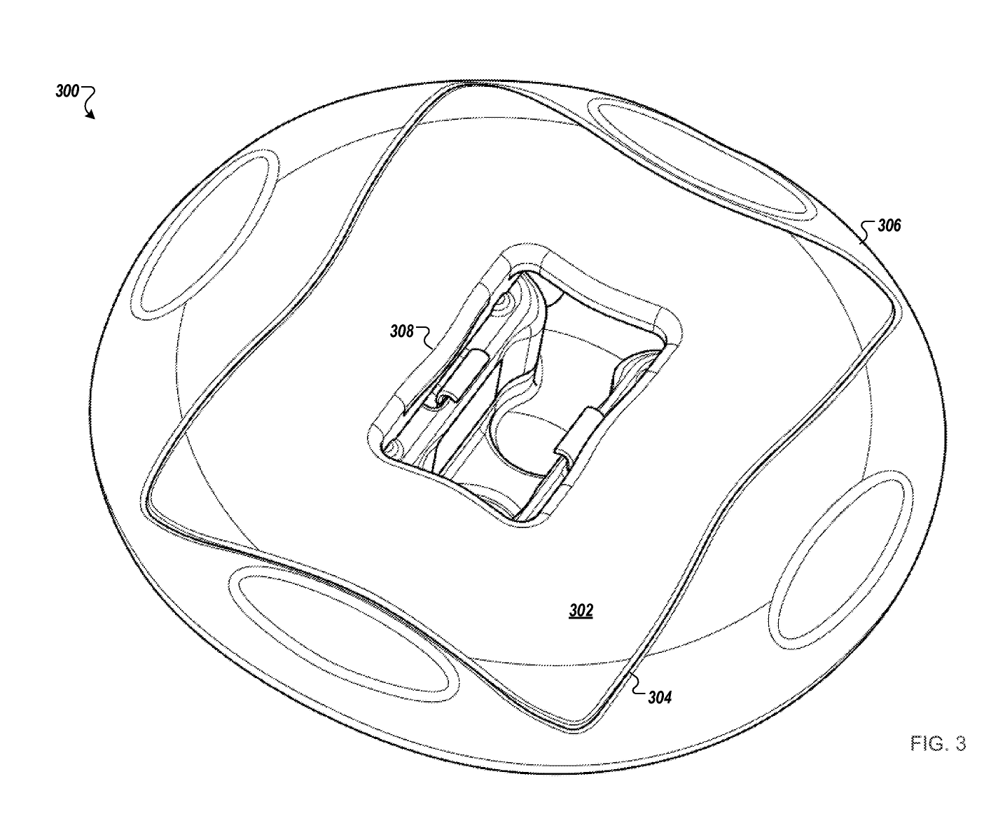

FIG. 3 is an illustration of an example disk-shaped physical interaction device 300 with a removable insert 302. In some implementations, a removable insert 302 sized and shaped to fit within the interior receptacle 304 of the body 306 of the physical interaction device. The removable insert includes an interior receptacle 308 sized and shaped to removably receive a personal electronic device therewithin. The interior receptacle 308 of the removable insert 302 is smaller in two dimensions than the interior receptacle 304 of the disk-shaped physical interaction device body 306. Thus, the removable insert permits a smaller personal handheld off-the-shelf electronic device to be used with the disk-shaped physical interaction device. For example, the interior receptacle 304 may be sized for a tablet and the interior receptacle 308 of the removable insert 302 may be sized for a smart phone.

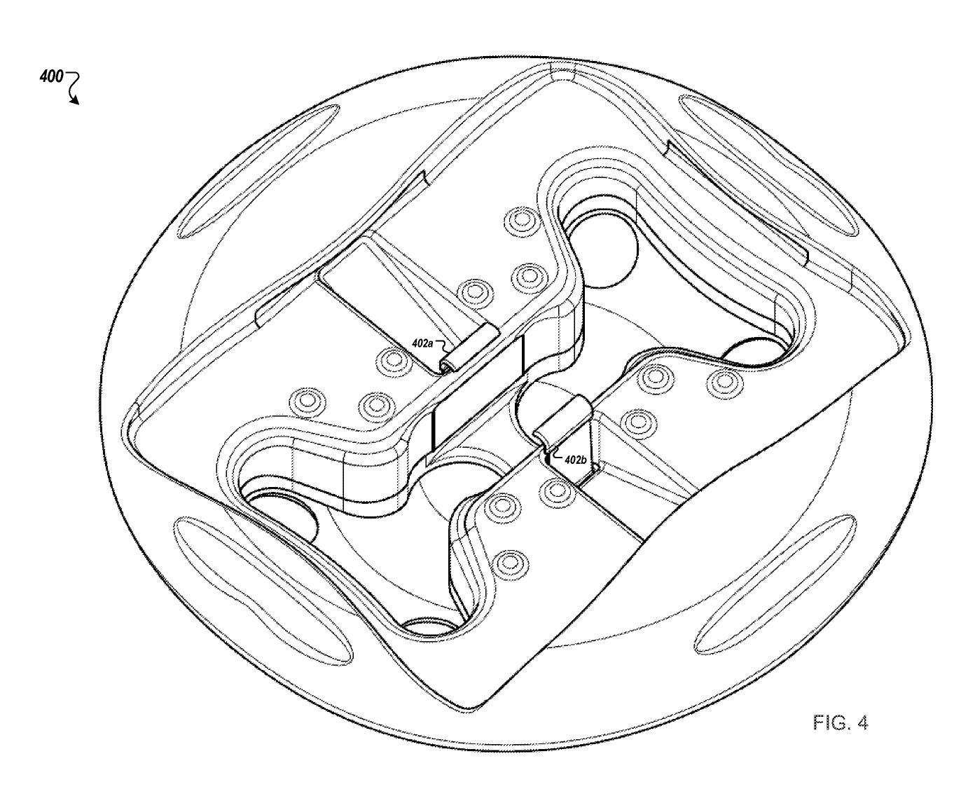

FIG. 4 is an example disk-shaped protective device 400 with a removable retention mechanism 402 for holding a personal electronic device. In some implementations, the retention mechanism 402 includes two or more retention clips 402a-b flexibly secured within the interior receptacle such that the two or more retention clips deflect as the personal electronic device is inserted into the retention clips 402. In some implementations, each of the two or more retention clips includes a lip to engage a surface of a personal electronic device upon full insertion of the personal electronic device into the retention clips 402, thereby securely retaining the personal electronic device within the physical interaction device until manipulation of the one or more retention clips by a user to release the personal electronic device from the second interior receptacle.

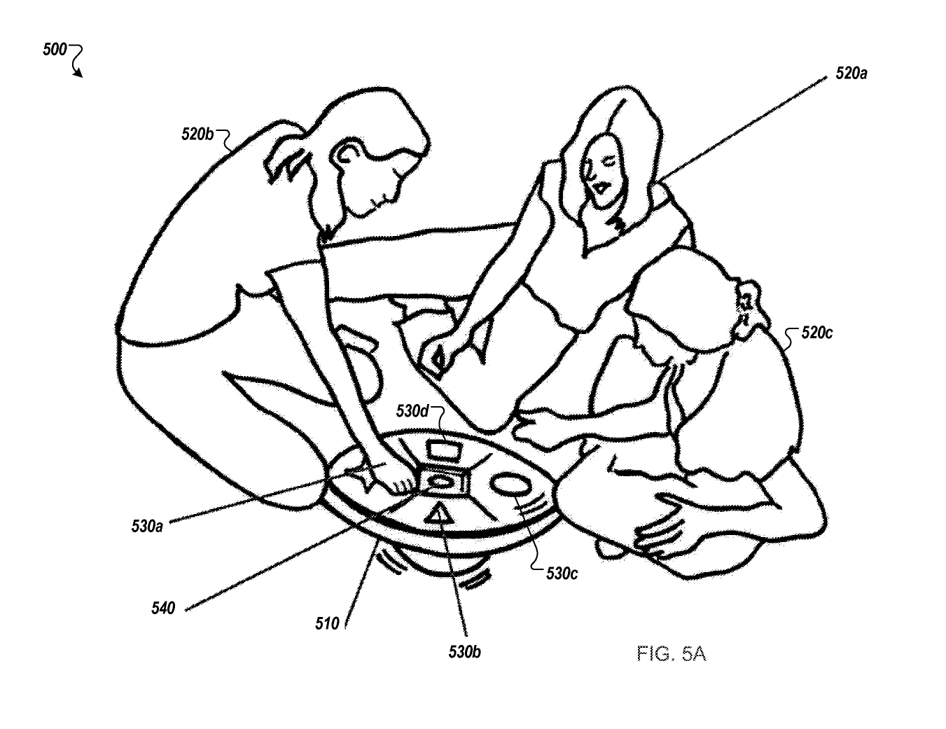

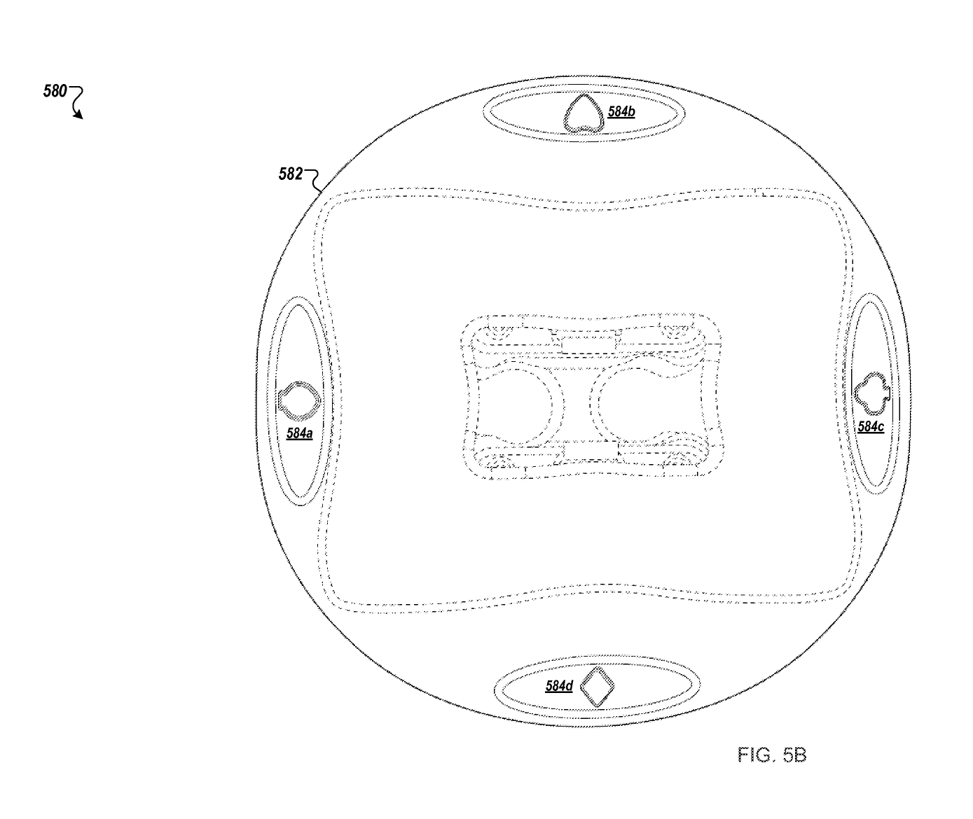

Turning to FIG. 5A, in some implementations, interactive game play may be enabled through a disc-shaped protective device 510. As shown in a game playing scene 500 involving three players 520, the disc-shaped protective device 510 may, in some examples, be spun, tilted, tapped, and/or tossed. As illustrated, the disc-shaped protective device 510 may include a series of symbols 530 (e.g., “virtual buttons” or contact regions). In some implementations, a slip cover may encase a portion of the disc-shaped protective device 510, for example creating game-specific surfaces, such as the series of symbols 530. In some examples, when a player 520 “presses” a particular region including one of the symbols 530, the change in attitude of a personal electronic device 540 may be sensed by one or more sensors built into the personal electronic device 540 and/or in communication with the personal electronic device 540. This sensor input, for example, may be as input in the game play scenario. For example, when a player taps a region including one of the symbols 530, the disc-shaped protective device 510 may tilt in the direction of the region of the disc-shaped protective device 510 that was tapped, thus altering the attitude and/or location of the personal electronic device 540 in a manner that may be identified through data collected via one or more sensors.

FIG. 5B is an illustration of an example disc-shape protective device 580 with a series of symbols 584 (e.g., unique marks or virtual buttons) on the body 582 of the physical interaction device. In some implementations, the series of symbols includes a spade 584a, a heart 584b, a clover/club 584c, and/or a diamond 584d. In some implementations, these symbols may map to a mobile application, such as a game, operating on a mobile personal electronic device that is fully inserted into the disk-shaped protective device 580.

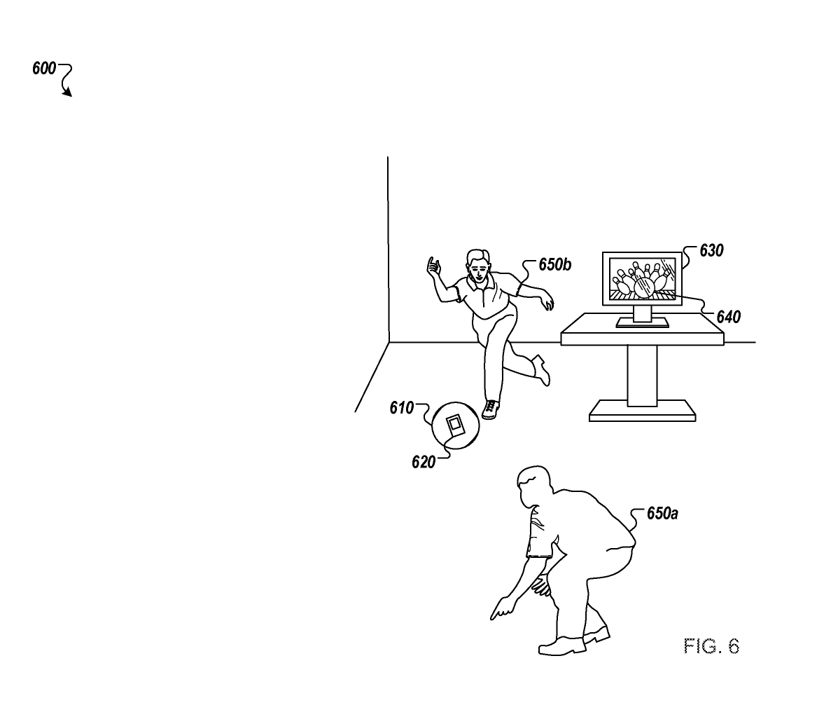

In some implementations, a ball-shaped protective device may be used in conjunction with a bowling alley software application. Turning to FIG. 6, a ball-shaped physical interaction-enabling device 610 may enclose a smart device 620 executing a bowling application to enable bowling interactive play as illustrated in an activity diagram 600. The bowling application may include software modules designed to interpret data received by one or more sensors resident within the smart device 620 and/or in communication with the smart device 620 to recognize movement from the ball-shaped physical interaction-enabling device 610. In some implementations, when a software module executing upon the smart device 620 interprets sensor input indicative of movement related to rolling the ball-shaped physical interaction-enabling device 610, the smart device 620 may display movement in a scene on a screen area of the smart device 620. The smart device 620, in some implementations, may communicate display information to a remote display 630, causing the display of movement in a scene 640 upon the remote display 630 (e.g., personal computer monitor, LCD display, television, or smart television (STV), etc.). For example, as illustrated, a trajectory of the ball-shaped physical interaction-enabling device 610 may be interpreted in relation to striking virtual bowling pins (e.g., as illustrated on the remote display 630). For example, a scene 640 on the remote display 630 may graphically illustrate the play action in real time (e.g., in a video mode). In some implementations, coordination between multiple smart devices in multiple ball-shaped physical interaction-enabling devices may enable multiple players 650 to compete in bowling. Coordination between the multiple ball-shaped physical interaction-enabling devices, in some examples, may be achieved by local or remote wireless communication such as, in some examples, radio frequency (RF) transmissions, Bluetooth® transmissions, cellular transmissions, or Wi-Fi™ transmissions.

In some implementations, various techniques utilizing the sensors internal to the smart device 620 and/or supplemental sensors upon or within the ball-shaped physical interaction-enabling device 610 or within the general play area surrounding the ball-shaped physical interaction-enabling device 610 may be used by a bowling software application executing in part on the smart device 620, in some examples, to create, maintain and utilize a virtual grid. For example, the virtual grid may track sensor data to estimate, substantially in real-time, a location and attitude of the smart device 620 and/or the ball-shaped physical interaction-enabling device 610. Further, in some implementations, a location and general physical attitude of a player 650a, for example, may be estimated based upon sensor data tracked in the virtual grid. The estimated location and attitude information may be used, in some implementations, by the bowling software application to present substantially accurate feedback to the player 650a upon the remote display 630.

In some implementations, in addition to the basic data collection from sensors in communication with a personal electronic device, complex software algorithms such as, for example, signal processing may be performed on sensor data. The complex software algorithms, in some examples, may be executed on the personal electronic device and/or at one or more remote computing devices accessible to the personal electronic device (e.g., through a wired or wireless network).

In some implementations, a personal electronic device is a speaker box with sensors, such as a gyroscope, accelerometer, GPS, compass, or other similar sensors. The speaker box may include a wireless communication system that enables the speaker box to communication with other devices, such as another personal electronic device (e.g., another personal electronic device used with another physical interaction device), a television, a stereo or speaker, a computer, or other electronic computing device, using Wifi, Bluetooth®, RF, or a wireless data connection. In some implementations, the speaker box sized and shaped to be removably inserted into the interior receptacle of a physical interaction device. In some implementations, a speaker box may be sized and shaped to fit within an interior receptacle of a physical interaction device or an interior receptacle of a removable insert configured to be used with a physical interaction device. In some implementations, a speaker box may be designed to be more impact resistant than a standard mobile phone. Thus, utilizing a speaker box with a physical interaction device permits more aggressive use patterns where the speaker box may be subjected to, and withstand, more impact than an off-the-shelf personal electronic device.

In some implementations, the physical interaction device includes first interior receptacle is sized and shaped to removably receive a speaker box, wherein the speaker box includes one or more sensors configured to detect movement of the speaker box, and a transmitter configured to wirelessly transmit data regarding the movement of the speaker box to an electronic device.

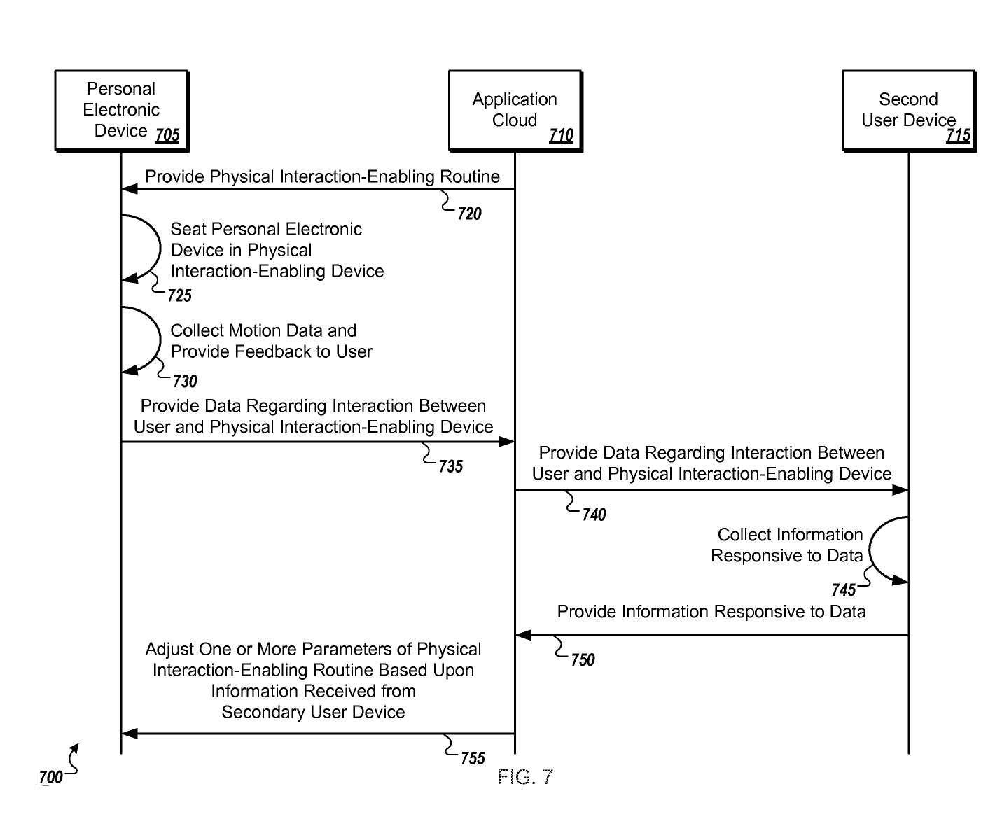

Turning now to FIG. 7, a swim lane diagram 700 details example interactions, provided for in some implementations, between a personal electronic device 705, an application cloud 710, and a second user device 715. The method illustrated by the swim lane diagram 700, in some implementations, may be used to monitor the activities of a user of a physical interaction-enabling device (e.g., if used by a rehabilitation patient, trainee, or student, etc.) or to engage in interactive play between two users, each for example using a respective physical interaction-enabling device.

The method, in some implementations, may begin with providing (720) a physical interaction-enabling routine to the personal electronic device 705. In some implementations, a user may log into a web site or another variety of online application store to purchase a software routine for download to the personal electronic device 705. In other implementations, the personal electronic device 705 may be sold with a copy of the physical interaction-enabling routine. In some implementations, the physical interaction-enabling routine may include device-resident software algorithms and one or more cloud-resident software algorithms that may be executed in tandem (e.g. via a network communications path). The physical interaction-enabling routine, in some implementations, may be specific to a style of physical interaction-enabling device. In some examples, the physical interaction-enabling routine may be formulated to function with an athletic equipment-style device, an imaginative play toy device, an outdoor activity device, or another device capable of enabling physical rich media-enhanced physical activity by accepting the personal electronic device 705 within a protective enclosure portion.

In some implementations, the personal electronic device may be seated (725) in a physical interaction-enabling device. As detailed above, the personal electronic device 705 may be removably inserted within a physical interaction-enabling device including a protective enclosure designed to hold and protect the personal electronic device. In some implementations, the protective enclosure may be designed to house a range of shapes and sizes of personal electronic devices. To accommodate various shapes and sizes of personal electronic devices, in some implementations the physical interaction-enabling device may be sold with a set of bumpers, spacers, or other adjustment equipment to accept differing shapes and sizes of personal electronic devices. In some examples, personal electronic devices may include a variety of cellular phones, smart phones, tablets, personal digital assistant devices, or other handheld or mobile computing devices such as personal gaming systems or multimedia players.

In some implementations, motion data may be collected (730) by the personal electronic device 705, and the personal electronic device 705 may provide feedback to the user responsive to the motion data. In some implementations, the personal electronic device 705 may collect motion data via one or more built-in sensors, such as, in some examples, an accelerometer, positioning sensor, orientation sensor, global positioning sensor, gyroscope, light sensor, imaging sensor, acoustic sensor, microphone, or camera. The personal electronic device 705, in some implementations, may be in wired or wireless communication with one or more external sensors, such as sensors built into the physical interaction-enabling device or sensors external to the physical interaction-enabling device.

Responsive to the collected motion data, in some implementations, the personal electronic device 705 may provide feedback to the user. In some implementations, the feedback may include audio, video, graphic, or tactile output presented to the user, for example through one or more devices built into the personal electronic device 705 (e.g., one or more lights (e.g., LED, etc.), speakers, a display screen area, etc.) or devices in communication with the personal electronic device 705 in a wired or wireless fashion (e.g., lights, a display area, or speakers built into the physical interaction-enabling device or external multimedia outputs such as, in some examples, a personal computer, television, display monitor, speaker system, stereo system, tablet computer, or laptop computing device).

In some implementations, the personal electronic device 705 may provide (735) data regarding interaction between the user and the physical interaction-enabling device to the application cloud 710. In some implementations, collected data may be uploaded and stored to the application cloud 710 as historic data. In some implementations for example involving the circumstance of an exercise program-enabling routine or a physical rehabilitation program-enabling routine, data uploaded may be stored and collected to provide, in some examples, statistical analysis information, a progress timeline, or a comparison with data collected during other sessions of interaction with the physical interaction-enabling device. The provided data, in some implementations, may be used for interactions with other players in the event of a multi-player style of game performed using the physical interaction-enabling device. For example, data collected from the personal electronic device 705 may be used to generate information for presentation to the second user device 715.

In some implementations, the application cloud 710 may provide (740) data regarding interactions between the user and the physical interaction-enabling device to the second user device 715. Although illustrated as a download, in some implementations the second user device 715 may poll or request data from the application cloud 710. Either way, data collected via the personal electronic device 705, in some implementations, may be manipulated into a set of data presented to the second user device 715. In some implementations, the second user device 715 may take the form of a computing device receiving information through a web site or other web portal regarding an ongoing rehabilitation or training routine being performed by the user of the personal electronic device 705. For example, the user at the second user device 715 may, in some implementations, be a doctor, personal trainer, or other professional working with the user of the personal electronic device 705 in a physical activity program involving the physical interaction-enabling device. In some implementations, the user at the second user device 715 may be the user of the personal electronic device 705. In some examples, a user may log into a web portal, access a web site, or launch a cloud-based application to review data collected during interaction with the physical interaction-enabling device while executing the physical interaction-enabling routine. The user, in some implementations, may review performance or adjust settings of the physical interaction-enabling routine using the second user device 715.

In some implementations, the second user device 715 may collect (745) information responsive to the data received. In some implementations, data collected may be indicative of interactions the second user has with the second user device 715 via a second physical interaction-enabling device (e.g., during an interactive gaming scenario). For example, during interactive game play, data may be provided from the personal electronic device 705 to the second user device 715 and vice-versa in near real-time to provide information necessary to virtual interaction. In some implementations, for example if two users are in the same room or same building, rather than passing data via the application cloud 710, the personal electronic device 705 and the second user device 715 may share data directly (e.g., via Bluetooth®, RF, Wi-Fi™, or other short range wireless messaging capability). In some implementations, even if the personal electronic device 705 and the second user device 715 may share certain data in a more direct manner, a portion of user data may be provided to the application cloud 710 (e.g., on a periodic basis, at the end of an interactive gaming session, etc.), for example for statistical collection purposes.

In other implementations, a user (e.g., the user of the personal electronic device 705, or another user such as, in some examples, a doctor, personal trainer, or parent) may adjust parameters associated with the physical interaction-enabling routine based in part upon reviewing data provided in response to the user's interactions with the physical interaction-enabling device. In some examples, a difficulty level of exercise regimen may be increased, a graphical user interface parameter may be adjusted (e.g., different character portrayal, language, character's speech accent, encouragement message setting, etc.), or additional features may be enabled (e.g., add the option of one or more additional rehabilitation exercises).

In some implementations, the second user device 715 may provide (750) information responsive to the data to the application cloud 710. In some examples, setting modifications, additional features, enhanced abilities, or user data regarding the second user device 715 may be uploaded to the application cloud 710, e.g. in a manner similar to that detailed above.

In some implementations, the application cloud 710 may provide information to the personal electronic device 705 responsive to information received from the second user device 715. The information provided to the personal electronic device 705, in some implementations, may be used to adjust (755) one or more parameters of the physical interaction-enabling routine. In some implementations, the information supplied may be used to enable features, adjust settings, or provide output related to the activities of a second user at the second user device 715.

In some implementations, more or fewer actions may take place between the personal electronic device 705, the application cloud 710, and the second user device 715. Furthermore, one or more of the actions described in relation to the swim lane diagram 700 may be executed in a different order than that which is described.

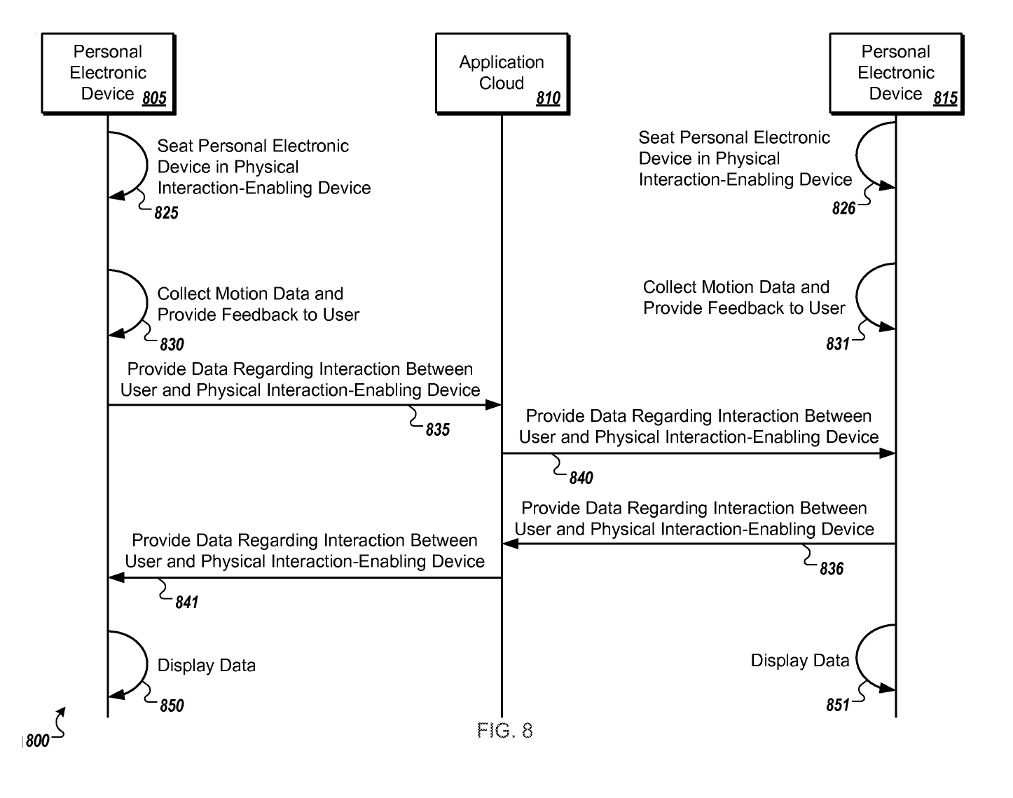

Turning now to FIG. 8, a swim lane diagram 800 details example interactions, provided for in some implementations, between a personal electronic device 805, an application cloud 810, and a second user device 815.

The method, in some implementations, may begin with seating a personal electronic device 805 (825) in a physical interaction-enabling device. Similarly, in some implementations, a second personal electronic device 815 is seated (826) in a second physical interaction device. As detailed above, the personal electronic devices 805 and 815 may be removably inserted within a physical interaction-enabling device including a protective enclosure designed to hold and protect the personal electronic device. In some implementations, the protective enclosure may be designed to house a range of shapes and sizes of personal electronic devices. To accommodate various shapes and sizes of personal electronic devices, in some implementations the physical interaction-enabling device may be sold with a set of bumpers, spacers, or other adjustment equipment to accept differing shapes and sizes of personal electronic devices. In some examples, personal electronic devices may include a variety of cellular phones, smart phones, tablets, personal digital assistant devices, or other handheld or mobile computing devices such as personal gaming systems or multimedia players.

In some implementations, motion data may be collected (830) by the personal electronic device 805, and the personal electronic device 805 may provide feedback to the user responsive to the motion data. In some implementations, the personal electronic device 805 may collect motion data via one or more built-in sensors, such as, in some examples, an accelerometer, positioning sensor, orientation sensor, global positioning sensor, gyroscope, light sensor, imaging sensor, acoustic sensor, microphone, or camera. The personal electronic device 805, in some implementations, may be in wired or wireless communication with one or more external sensors, such as sensors built into the physical interaction-enabling device or sensors external to the physical interaction-enabling device.

In some implementations, motion data may be collected (831) by the personal electronic device 815, and the personal electronic device 815 may provide feedback to the user responsive to the motion data. In some implementations, the personal electronic device 815 may collect motion data via one or more built-in sensors, such as, in some examples, an accelerometer, positioning sensor, orientation sensor, global positioning sensor, gyroscope, light sensor, imaging sensor, acoustic sensor, microphone, or camera. The personal electronic device 815, in some implementations, may be in wired or wireless communication with one or more external sensors, such as sensors built into the physical interaction-enabling device or sensors external to the physical interaction-enabling device.

Responsive to the collected motion data, in some implementations, the personal electronic devices 805 and 815 may provide feedback to the user. In some implementations, the feedback may include audio, video, graphic, or tactile output presented to the user, for example through one or more devices built into the personal electronic devices 805 and 815 (e.g., one or more lights (e.g., LED, etc.), speakers, a display screen area, etc.) or devices in communication with the personal electronic devices 805 and 815 in a wired or wireless fashion (e.g., lights, a display area, or speakers built into the physical interaction-enabling device or external multimedia outputs such as, in some examples, a personal computer, television, display monitor, speaker system, stereo system, tablet computer, or laptop computing device).

In some implementations, the personal electronic device 805 may provide (835) data regarding interaction between the user and the physical interaction-enabling device to the application cloud 810. In some implementations, collected data may be uploaded and stored to the application cloud 810 as historic data. In some implementations for example involving the circumstance of an exercise program-enabling routine or a physical rehabilitation program-enabling routine, data uploaded may be stored and collected to provide, in some examples, statistical analysis information, a progress timeline, or a comparison with data collected during other sessions of interaction with the physical interaction-enabling device. The provided data, in some implementations, may be used for interactions with other players in the event of a multi-player style of game performed using the physical interaction-enabling device. For example, data collected from the personal electronic device 805 may be used to generate information for presentation to the second user device 815.

In some implementations, the application cloud 810 may provide (840) data regarding interactions between the user and the physical interaction-enabling device to the second user device 815. Although illustrated as a download, in some implementations the second user device 815 may poll or request data from the application cloud 810. Either way, data collected via the personal electronic device 805, in some implementations, may be manipulated into a set of data presented to the second user device 815. In some implementations, the second user device 815 may take the form of a computing device receiving information through a web site or other web portal regarding an ongoing rehabilitation or training routine being performed by the user of the personal electronic device 805. For example, the user at the second user device 815 may, in some implementations, be a doctor, personal trainer, or other professional working with the user of the personal electronic device 805 in a physical activity program involving the physical interaction-enabling device. In some implementations, the user at the second user device 815 may be the user of the personal electronic device 805. In some examples, a user may log into a web portal, access a web site, or launch a cloud-based application to review data collected during interaction with the physical interaction-enabling device while executing the physical interaction-enabling routine. The user, in some implementations, may review performance or adjust settings of the physical interaction-enabling routine using the second user device 815.

In some implementations, the personal electronic device 815 may provide (836) data regarding interaction between the user and the physical interaction-enabling device to the application cloud 810. In some implementations, collected data may be uploaded and stored to the application cloud 810 as historic data.

In some implementations, the application cloud 810 may provide (841) data regarding interactions between the user and the physical interaction-enabling device to the personal electronic device 805. Although illustrated as a download, in some implementations the personal electronic device 805 may poll or request data from the application cloud 810. Either way, data collected via the personal electronic device 815, in some implementations, may be manipulated into a set of data presented to the personal electronic device 805.

In some implementations, more or fewer actions may take place between the personal electronic device 805, the application cloud 810, and the second user device 815. Furthermore, one or more of the actions described in relation to the swim lane diagram 800 may be executed in a different order than that which is described.

In some implementations, the personal electronic device 805 displays (850) information on the display screen of the personal electronic device based on both the motion data collected from the personal electronic device 805 and the motion data collected and received from the personal electronic device 815. Similarly, in some implementations, the personal electronic device 815 displays (851) information on the display screen of the personal electronic device based on both the motion data collected from the personal electronic device 815 and the motion data collected and received from the personal electronic device 805. For example, as explained below. The personal electronic device 805 and 815 may be used to play a competitive-cooperative game, such as a labyrinth game. The devices 805 and 815 may each display the “marble” that a team is moving using its own physical interaction device and personal electronic device as well as the “marble” that its opponent is moving using its own physical interaction device and personal electronic device.

In some implementations, the personal electronic device 805 and the personal electronic device 815 communicate directly with each other using a wireless connection, such as a Wifi, Bluetooth®, or wireless data connection.

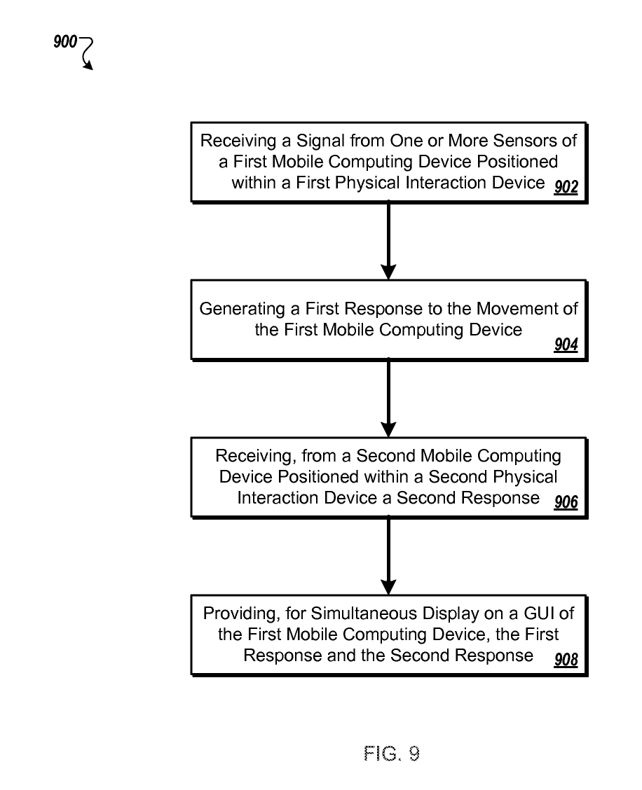

FIG. 9 is an illustration of an example method 900 of implementing an interactive competitive-cooperative game involving a plurality of physical interaction devices each containing a mobile computing device. In some implementations, the method 900 includes receiving, by a processor of a first mobile computing device, a signal from each of one or more sensors associated with the first mobile computing device responsive to a movement of the first mobile computing device (902). The first mobile computing device is positioned within an interior receptacle portion of a first physical interaction device, the interior receptacle portion being configured to substantially enclose and protect the first mobile computing device during movement. In some implementations, a first plurality of users cooperate to move the first physical interaction device.

In some implementations, the method 900 includes generating a first response to the movement of the first mobile computing device (904). The response includes graphic output and, optionally, one or more of audio and tactile output.

In some implementations, the method 900 includes receiving, from a second mobile computing device positioned within an interior receptacle portion of a second physical interaction device, a second response to a behavior of a second plurality of users of the second physical interaction device based in part upon movement of the second physical interaction device determined from one or more sensors of the second mobile computing device (906). In some implementations, the second plurality of users cooperate to move the second physical interaction device.

In some implementations, the method 900 includes providing, for simultaneous display on a graphical user interface of the first mobile computing device, the first response and the second response (908).

As described above, each of the physical interaction devices used in method 900 may be made from a material selected from one or more of open cell foam, closed cell foam, foamed resin, and an inflatable bladder. The housing of both the first and second physical interaction devices may be a disk-shaped housing sized and shaped such that each user of the first plurality of users can touch a side of said housing causing said housing to tilt in a direction of a touch. Each of the housings of the first and second physical interaction devices may include a window/opening for viewing of the first mobile computing device when retained within the interior receptacle portion. For example, the physical interaction devices used in a competitive-cooperative game, such as described in method 900, may be the disc-shaped physical interaction devices described above (see e.g., FIGS. 1 through 5B).

An example of a competitive-cooperative game is a spaceship obstacle course game that is a cooperative game of flying a spaceship through an obstacle course, either for lowest time or against another spaceship team. The game may permit several teams to compete against each other. In some implementations, a game may operate in a single or multi-player mode. In some implementations, a game may also permit a user to select a level or difficulty.

For example, in a spaceship obstacle game, players may cooperatively fly a small spaceship through a 3D obstacle course. In the center of the screen, in some implementations, is the players' shared ship pointing in the direction of movement, with flames coming out of the back. The spaceship may appear to travel at a set speed. The speed may increase at harder levels, or might have speed-ups or speed-downs during a course. In some implementations, the speed should be fast enough to create tension and have the team miss some obstacles (either by not making it through the entrance or hitting the obstacle) if difficulty is too hard.

Competitive-cooperative games may be implemented using two or more physical interaction devices, each used with a mobile computing device. For example, in the spaceship obstacle course game, two teams of players may compete against each other. Each team may use a disk-shaped physical interaction device, such as the device described above, with a mobile computing device. Each player on a team may control one of the four directions the ship might go in: left, right, up, and down (note the ship should have a clear up and down and not be a round tube). Thus, when one player presses down on the edge of the disk in the ‘down’ direction, the ship will start going down in the level. If another player also presses on the ‘left’ position, the ship will go down and left. If players on opposite sides of the disk press down at the same time, the ship goes where the smart device is pointing. Each team will work together to navigate its respective ship through the 3D obstacle course. The obstacles may include, for example, hoops (small and large, a series of hoops set close together (straight or curved), short transparent tubes that can be either straight or curved, longer transparent tubes that can be straight or curved, and asteroid belts the ships have to maneuver through. The obstacles may be fixed objects in space except asteroids may wander around in a fixed area. If a ship touches any obstacle or hoop, the ship will significantly slow down. In some implementations, a team's ship must traverse a series of hoops in the correct order to finish a level. Obstacles might obscure the entrance to the hoop (asteroids) or might be attached to the hoop (tunnels, series of hoops). The next hoop the ship must fly through may be highlighted in some way (lit up or flashing lights). There may also be a 3D pointer that points to the next hoop if needed. As a team goes through each hoop in the correct order, feedback or a progress bar may be used to let the team know they successfully went through, for example, Hoop #5 and that there are 7 more hoops to go.

In some implementations, competitive-cooperative games played using a physical interaction device may include different modes of operation. For example, the spaceship obstacle course may include a race mode and a combat mode. During race mode, ships from various teams cannot influence each other. Each team may be able see a ‘ghost’ of the other ship, and they can fly right through each other. In combat mode, ships may be able to hit each other and cause them to go off course. For example, if one ship ‘body-slams’ the other ship just before it is about to enter a hoop, it might force the hit ship to miss the entrance and thus have to loop back to enter the hoop.

Competitive-cooperative games may operate in multiplayer mode using Wifi, Bluetooth®, RF or a wireless data connection. In some implementations, a team may see or track the progress or position of another team when they are competing.

Another example of a competitive-cooperative game is a trivia game. The trivia game may be played using two or more physical interaction devices, such as the disk described above, each with a mobile computing device fully inserted into the physical interaction device. All players at one disk are on the same team, and points are scored by team.

Multiple teams may play against each other and each team may have multiple players. Who (individual or team) has the highest score at the end of a certain number of questions is declared winner (“The red player on disk 2 wins with 20 points!”).

For example, the game audio says the trivia question (“How many days in an average year?”), after which the question appears on the screen with possible answers, each colored a different player color, with a random orientation (or maybe oriented to the player with the least points). [“How many days in an average year? 1:365.0 (in red) 2: 365.25 (in green) 3: 365.75 (in blue) 4: 366.0 (in yellow)”]. In some implementations, there will always be 4 possible answers. The edge of the screen may have the color corresponding to the disk color that should be on the same side. At any point, a player can press down their side of the disk to get a chance to answer. Once the game recognizes a player wanting to answer, the game announces the player with audio, the answer and questions are shown on the screen if not already, and the screen flashes the color of the player. Once announced, the player has, for example, 4 seconds to press the side of the disk corresponding to the correct answer. If correct, the game yells “Correct!” and announces how many points were won. If the player is wrong, the game says “I am sorry, but that answer is incorrect, the correct answer is 365.25” and announces how many points the player lost. If the player does not answer in time, the game says “Buzz—too slow! The correct answer is 365.25. You have lost 30 points.” If no players tilt the disk to give an answer in 10 seconds after question and possible answers are shown on the screen (no one knows the answer), the game announces “Beep! Well, it seems no one got this question. The correct answer is 365.25”.

Another example of a competitive-cooperative game is a 3D labyrinth game. The 3D labyrinth game may be played using two or more physical interaction devices, such as the disk described above, each with a mobile computing device fully inserted into the physical interaction device. A 3D Labyrinth type game may be a ball bearing going through a maze. The level of the maze (and thus ball direction) may be controlled by four players. For example, each player can depress the maze (e.g., the disk-shaped physical interaction device with the mobile computing device fully inserted) in their direction. Thus, when the player at the ‘top’ position of the maze presses down on their edge of the disk, the ball will start to roll in the ‘top’ direction. If the ‘top’ and ‘right’ positions both press down on the disk, the ball will move in the direction between their positions (towards the lowest point on the disk). Players can race other players playing the game on a second disk. A ghosted ball of their opponents will be shown in their game (and vice versa) for each team to race against. In advanced games, teams will be able to physically interact with their opponent's ball and affect their game. In some implementations, the labyrinth game involves moving a ball from starting position to end destination hole, while avoiding traps in-between (non-destination holes). In some implementations, the labyrinth game is a 3D game with ramps, drops, escalators, etc.

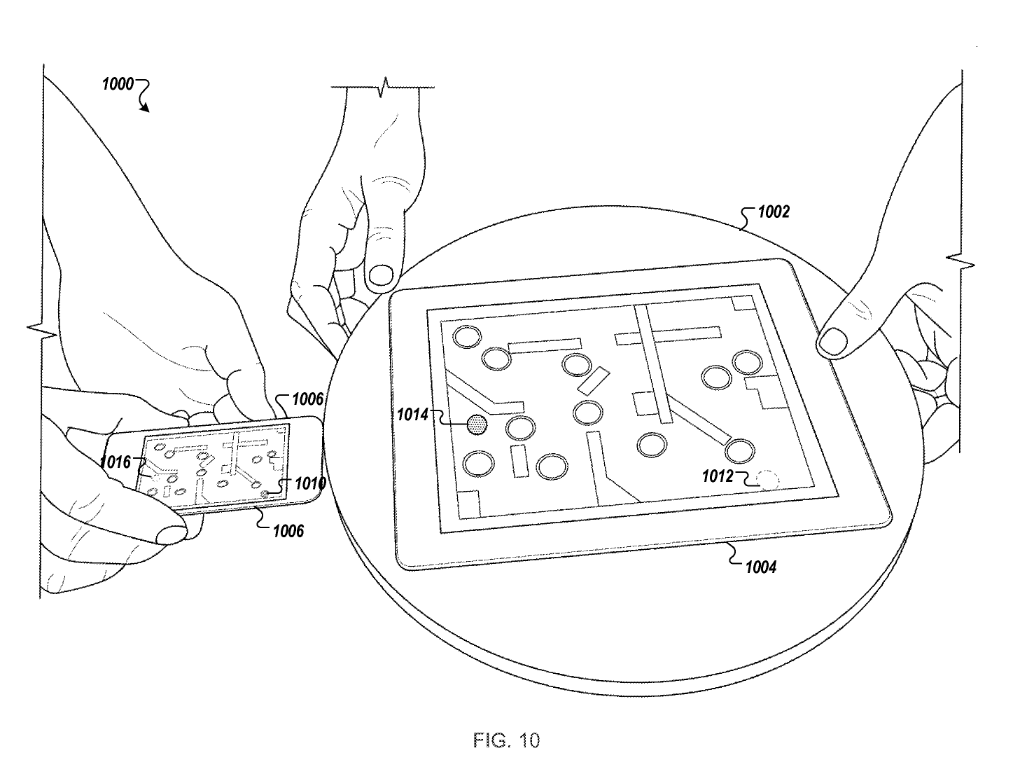

FIG. 10 illustrates an example labyrinth game 1000 played using a physical interaction device 1002. In this example, two players are playing the labyrinth game against each other. A first player is playing using a tablet computing device 1004 fully inserted into a disk-shaped physical interaction device 1002. The disk-shaped physical interaction device 1002 may be, for example, the disk-shaped physical interaction device shown in FIG. 1. A second player is playing using a mobile phone 1006. The second player could use a disk-shaped interaction device as well, such as the disk-shaped interaction device shown in FIG. 3. The first player's ball 1014 is shown on his/her tablet computing device 1004. The second player's ball 1010 is also shown on his/her tablet computing device 1004 as ball 1012 and it may be ghosted so that the player can differentiate between the two balls. Similarly, the second player's ball 1010 is shown on his/her mobile phone 1006. The first player's ball 1014 is also shown on his/her mobile phone 1006 as ball 1016. The tablet computing device 1004 and the mobile phone 1006 may communicate with each other using Wifi, Bluetooth®, RF, or a wireless data connection.

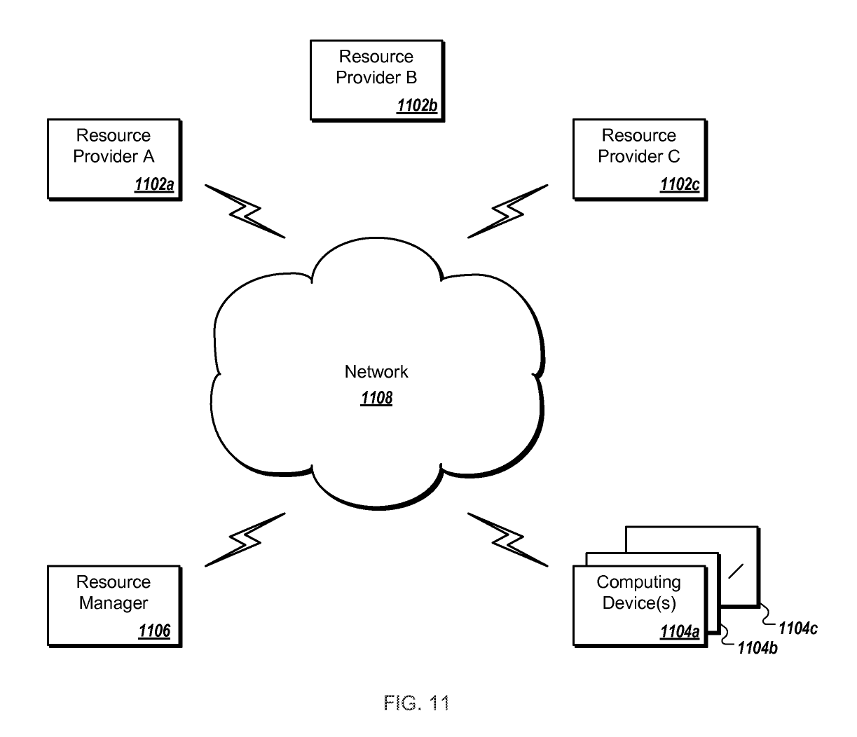

As shown in FIG. 11, an implementation of a network environment 1100 for interaction with a personal electronic device via a protective device is shown and described. In brief overview, Referring now to FIG. 11, a block diagram of an exemplary cloud computing environment 1100 is shown and described. The cloud computing environment 1100 may include one or more resource providers 1102a, 1102b, 1102c (collectively, 1102). Each resource provider 1102 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1102 may be connected to any other resource provider 1102 in the cloud computing environment 1100. In some implementations, the resource providers 1102 may be connected over a computer network 1108. Each resource provider 1102 may be connected to one or more computing device 1104a, 1104b, 1104c (collectively, 1104), over the computer network 1108.

The cloud computing environment 1100 may include a resource manager 1106. The resource manager 1106 may be connected to the resource providers 1102 and the computing devices 1104 over the computer network 1108. In some implementations, the resource manager 1106 may facilitate the provision of computing resources by one or more resource providers 1102 to one or more computing devices 1104. The resource manager 1106 may receive a request for a computing resource from a particular computing device 1104. The resource manager 1106 may identify one or more resource providers 1102 capable of providing the computing resource requested by the computing device 1104. The resource manager 1106 may select a resource provider 1102 to provide the computing resource. The resource manager 1106 may facilitate a connection between the resource provider 1102 and a particular computing device 1104. In some implementations, the resource manager 1106 may establish a connection between a particular resource provider 1102 and a particular computing device 1104. In some implementations, the resource manager 1106 may redirect a particular computing device 1104 to a particular resource provider 1102 with the requested computing resource.

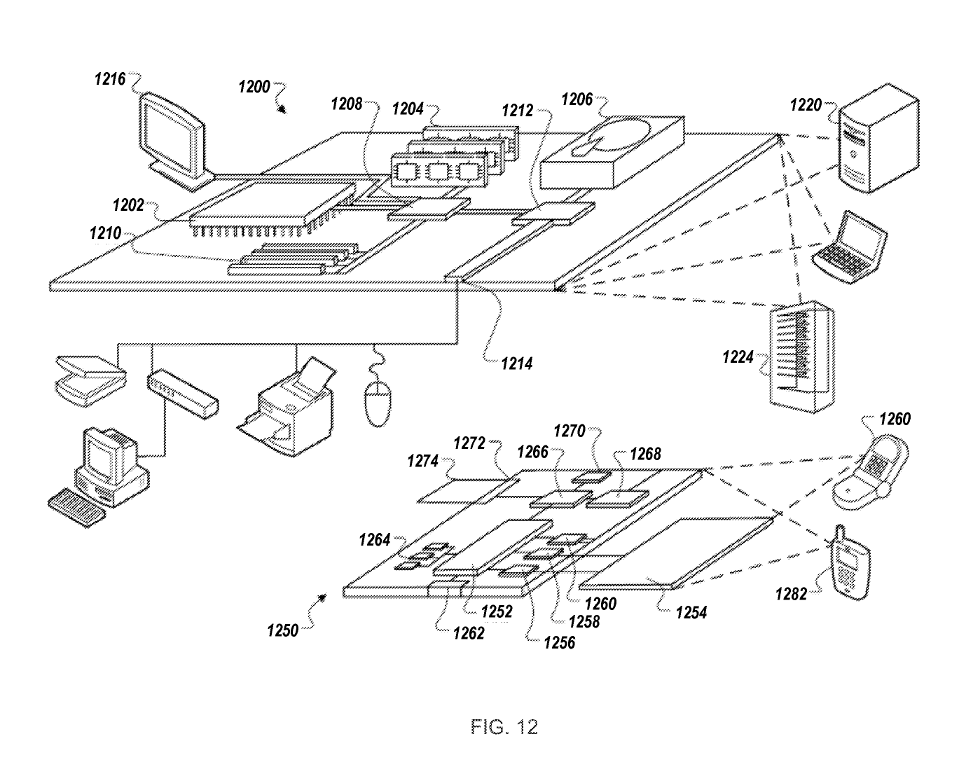

FIG. 12 shows an example of a computing device 1200 and a mobile computing device 1250 that can be used to implement the techniques described in this disclosure. The computing device 1200 is intended to represent various forms of digital computers, such as laptops, desktops, workstations, personal digital assistants, servers, blade servers, mainframes, and other appropriate computers. The mobile computing device 1250 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1200 includes a processor 1202, a memory 1204, a storage device 1206, a high-speed interface 1208 connecting to the memory 1204 and multiple high-speed expansion ports 1210, and a low-speed interface 1212 connecting to a low-speed expansion port 1214 and the storage device 1206. Each of the processor 1202, the memory 1204, the storage device 1206, the high-speed interface 1208, the high-speed expansion ports 1210, and the low-speed interface 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as a display 1216 coupled to the high-speed interface 1208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1204 stores information within the computing device 1200. In some implementations, the memory 1204 is a volatile memory unit or units. In some implementations, the memory 1204 is a non-volatile memory unit or units. The memory 1204 may also be another form of computer-readable medium, such as a magnetic or optical disk.

The storage device 1206 is capable of providing mass storage for the computing device 1200. In some implementations, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1202), perform one or more methods, such as those described above. The instructions can also be stored by one or more storage devices such as computer- or machine-readable mediums (for example, the memory 1204, the storage device 1206, or memory on the processor 1202).

The high-speed interface 1208 manages bandwidth-intensive operations for the computing device 1200, while the low-speed interface 1212 manages lower bandwidth-intensive operations. Such allocation of functions is an example only. In some implementations, the high-speed interface 1208 is coupled to the memory 1204, the display 1216 (e.g., through a graphics processor or accelerator), and to the high-speed expansion ports 1210, which may accept various expansion cards (not shown). In the implementation, the low-speed interface 1212 is coupled to the storage device 1206 and the low-speed expansion port 1214. The low-speed expansion port 1214, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. In addition, it may be implemented in a personal computer such as a laptop computer 1222. It may also be implemented as part of a rack server system 1224. Alternatively, components from the computing device 1200 may be combined with other components in a mobile device (not shown), such as a mobile computing device 1250. Each of such devices may contain one or more of the computing device 1200 and the mobile computing device 1250, and an entire system may be made up of multiple computing devices communicating with each other.

The mobile computing device 1250 includes a processor 1252, a memory 1264, an input/output device such as a display 1254, a communication interface 1266, and a transceiver 1268, among other components. The mobile computing device 1250 may also be provided with a storage device, such as a micro-drive or other device, to provide additional storage. Each of the processor 1252, the memory 1264, the display 1254, the communication interface 1266, and the transceiver 1268, are interconnected using various buses, and several of the components may be mounted on a common motherboard or in other manners as appropriate.

The processor 1252 can execute instructions within the mobile computing device 1250, including instructions stored in the memory 1264. The processor 1252 may be implemented as a chipset of chips that include separate and multiple analog and digital processors. The processor 1252 may provide, for example, for coordination of the other components of the mobile computing device 1250, such as control of user interfaces, applications run by the mobile computing device 1250, and wireless communication by the mobile computing device 1250.

The processor 1252 may communicate with a user through a control interface 1258 and a display interface 1256 coupled to the display 1254. The display 1254 may be, for example, a TFT (Thin-Film-Transistor Liquid Crystal Display) display or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may provide communication with the processor 1252, so as to enable near area communication of the mobile computing device 1250 with other devices. The external interface 1262 may provide, for example, for wired communication in some implementations, or for wireless communication in other implementations, and multiple interfaces may also be used.

The memory 1264 stores information within the mobile computing device 1250. The memory 1264 can be implemented as one or more of a computer-readable medium or media, a volatile memory unit or units, or a non-volatile memory unit or units. An expansion memory 1274 may also be provided and connected to the mobile computing device 1250 through an expansion interface 1272, which may include, for example, a SIMM (Single In Line Memory Module) card interface. The expansion memory 1274 may provide extra storage space for the mobile computing device 1250, or may also store applications or other information for the mobile computing device 1250. Specifically, the expansion memory 1274 may include instructions to carry out or supplement the processes described above, and may include secure information also. Thus, for example, the expansion memory 1274 may be provide as a security module for the mobile computing device 1250, and may be programmed with instructions that permit secure use of the mobile computing device 1250. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1252), perform one or more methods, such as those described above. The instructions can also be stored by one or more storage devices, such as one or more computer- or machine-readable mediums (for example, the memory 1264, the expansion memory 1274, or memory on the processor 1252). In some implementations, the instructions can be received in a propagated signal, for example, over the transceiver 1268 or the external interface 1262.

The mobile computing device 1250 may communicate wirelessly through the communication interface 1266, which may include digital signal processing circuitry where necessary. The communication interface 1266 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1268 using a radio-frequency. In addition, short-range communication may occur, such as using a Bluetooth®, Wi-Fi™, or other such transceiver (not shown). In addition, a GPS (Global Positioning System) receiver module 1270 may provide additional navigation- and location-related wireless data to the mobile computing device 1250, which may be used as appropriate by applications running on the mobile computing device 1250.

The mobile computing device 1250 may also communicate audibly using an audio codec 1260, which may receive spoken information from a user and convert it to usable digital information. The audio codec 1260 may likewise generate audible sound for a user, such as through a speaker, e.g., in a handset of the mobile computing device 1250. Such sound may include sound from voice telephone calls, may include recorded sound (e.g., voice messages, music files, etc.) and may also include sound generated by applications operating on the mobile computing device 1250.

The mobile computing device 1250 may be implemented in a number of different forms, as shown in the figure. For example, it may be implemented as a cellular telephone 1280. It may also be implemented as part of a smart-phone 1282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a protective device for enabling physical interaction with a personal electronic device and methods for interacting with a personal electronic device using a protective device are provided. Having described certain implementations of methods and apparatus for supporting interactions with a personal electronic device using a physical interaction-enabling device with a protective enclosure for the personal electronic device, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method of implementing an interactive competitive-cooperative game involving a plurality of physical interaction devices each containing a mobile computing device, the method comprising:
receiving, by a processor of a first mobile computing device, a signal from each of one or more sensors associated with the first mobile computing device responsive to a movement of the first mobile computing device, wherein the first mobile computing device is positioned within an interior receptacle portion of a first physical interaction device, the interior receptacle portion being configured to substantially enclose and protect the first mobile computing device during movement, wherein a first plurality of users cooperate to move the first physical interaction device;
generating a first response to the movement of the first mobile computing device, said response comprising graphic output and, optionally, one or more of audio and tactile output;
receiving, from a second mobile computing device positioned within an interior receptacle portion of a second physical interaction device, a second response to a behavior of a second plurality of users of the second physical interaction device based in part upon movement of the second physical interaction device determined from one or more sensors of the second mobile computing device, wherein the second plurality of users cooperate to move the second physical interaction device; and
providing, for simultaneous display on a graphical user interface of the first mobile computing device, the first response and the second response.

2. The method of claim 1, wherein the first physical interaction device comprising a housing comprising a material selected from one or more of open cell foam, closed cell foam, foamed resin, and an inflatable bladder, and the second physical interaction device comprising a housing comprising a material selected from one or more of open cell foam, closed cell foam, foamed resin, and an inflatable bladder.

3. The method of claim 2, wherein:
the housing of the first physical interaction devices is a disk-shaped housing sized and shaped such that each user of the first plurality of users can touch a side of said housing causing said housing to tilt in a direction of a touch, and
the housing of the second physical interaction device is a disk-shaped housing sized and shaped such that each user of the second plurality of users can touch a side of said housing causing said housing to tilt in a direction of a touch.

4. The method of claim 2, wherein the housing of the first physical interaction device comprising a window/opening for viewing of the first mobile computing device when retained within the interior receptacle portion and the housing of the second physical interaction device comprising a window/opening for viewing of the second mobile computing device when retained within the interior receptacle portion.

5. The method of claim 2, wherein the housing of the first physical interaction device and the housing of the second interaction device each comprise one or more unique marks associated with a mobile application operating on the first mobile computing device and a mobile application operating the second mobile computing device, respectively.

6. The method of claim 5, wherein the one or more unique marks comprise a heart, a spade, a club, and a diamond.

7. The method of claim 1, wherein the first mobile computing device is a smart phone and the second mobile computing device is a tablet computing device.

8. The method of claim 1, wherein the first plurality of users and the second plurality of users are competing using the first and second physical interaction devices, respectively.

9. A physical interaction device comprising:
a disk-shaped housing sized and shaped such that one or more users can touch a side of the housing causing the housing to tilt in a direction of the touch, the housing comprising a first interior receptacle sized and shaped to removably receive a first personal electronic device therewithin, wherein
the first interior receptacle comprising at least one undercut such that an edge of the first personal electronic device, upon positioning of the device within the first interior receptacle, is secured within the at least one undercut to firmly retain the first personal electronic device within the first interior receptacle, and
the first personal electronic device is a handheld off-the-shelf electronic device; and
a removable insert sized and shaped to fit within the first interior receptacle, the removable insert comprising a second interior receptacle sized and shaped to removably receive a second personal electronic device therewithin, wherein the second personal electronic device is smaller in two dimensions than the first personal electronic device and is a handheld off-the-shelf electronic device.

10. The physical interaction device of claim 9, wherein the physical interaction device is sized and shaped to (i) substantially enclose and protect the personal electronic device within the interior receptacle during physical activity comprising at least one of rolling the device, throwing the device, kicking the device, and striking the device against another object, and (ii) enable interaction with the personal electronic device while the personal electronic device is substantially enclosed within the device.

11. The physical interaction device of claim 9, wherein the housing comprising a window/opening for viewing of the first personal electronic device when retained within the interior receptacle and the removable insert comprising a window/opening for viewing of the second personal electronic device when retained within the interior receptacle.

12. The physical interaction device of claim 9, wherein the physical interaction device is configured to be used as cooperative-competitive gaming equipment.

13. The physical interaction device of claim 9, wherein the first personal electronic device is a tablet and the second personal electronic device is a cellular phone.

14. The physical interaction device of claim 9, wherein the housing comprising one or more unique marks associated with a mobile application operating on at least one of the first personal electronic device and the second personal electronic device.

15. The physical interaction device of claim 15, wherein the one or more unique marks comprise a heart, a spade, a club, and a diamond.

16. The physical interaction device of claim 9, wherein the first personal electronic device is configured to store instructions, that when executed cause a processor the personal electronic device to:
receive a signal from each of one or more sensors associated with the first mobile computing device responsive to a movement of the first mobile computing device, wherein a first plurality of users cooperate to move the disk-shaped interaction device;
generating a response to the movement of the first mobile computing device, said response comprising graphic output and, optionally, one or more of audio and tactile output;
receiving, from a mobile computing device positioned in a second physical interaction device, a second response to a behavior of a second plurality of users of the second physical interaction device based in part upon movement of the second physical interaction device determined from one or more sensors of the mobile computing device, wherein the second plurality of users cooperate to move the second physical interaction device; and
providing, for simultaneous display on a graphical user interface of the first mobile computing device, the first response and the second response.

17. The physical interaction device of claim 9, wherein the housing comprising a top, bottom, and one or more edges between the top and bottom, and a width of the housing is larger than a thickness of the housing, wherein the thickness of the housing varies such that the thickness at the one or more edges is smaller than the thickness at a center of the housing.

18. The physical interaction device of claim 9, wherein the housing comprising at least one of an open cell foam, closed cell foam, a foamed resin, and an inflatable bladder, and the removable insert comprising at least one of an open cell foam, closed cell foam, a foamed resin, and an inflatable bladder.

19. The physical interaction device of claim 9, wherein the second interior receptacle comprising at least one receptacle undercut such that an edge of the second personal electronic device, upon positioning of the device within the second interior receptacle, is secured within the at least one receptacle undercut to firmly retain the second personal electronic device within the second interior receptacle.

20. The physical interaction device of claim 9, wherein the first interior receptacle is sized and shaped to removably receive a speaker box, wherein the speaker box includes one or more sensors configured to detect movement of the speaker box, and a transmitter configured to wirelessly transmit data regarding the movement of the speaker box to an electronic device.
